(19) United States
(12) Patent Application Publication
(10) Pub. No.: US 2026/0099392 A1
(43) Pub. Date: Apr. 9, 2026

(54) Rule-based Cross-Tenancy Event Delivery

(71) Applicant: Oracle International Corporation, Redwood Shores, CA (US)

(72) Inventors: Kripa Kanchana Sivakumar, Seattle, WA (US); Suman M. Somasundar, San Jose, CA (US); Sriram Ananthakrishnan, Atlanta, GA (US)

(21) Appl. No.: 18/906,986

(22) Filed: Oct. 4, 2024

(51) Int. Cl. G06F 9/54; G06F 21/60; G06F 21/62

(52) U.S. Cl. CPC G06F 9/542; G06F 21/602; G06F 21/62

(57) ABSTRACT

In one embodiment, a method includes receiving from a service executing in a service tenancy and by an event broker, a request to modify a rule to deliver a set of events from a first tenancy to the service tenancy. Modify may include at least one of create or update. The method also includes receiving from the service and by the event broker, a proxy token for substantiating the request. The proxy token represents an authority of a user principal of the first tenancy. The method further includes determining, by the event broker, whether modification of the rule is authorized based at least on the authority of the user principal, and subsequent to determining that the modification of the rule is authorized, delivering, by the event broker, the set of events from the first tenancy to the service tenancy according to the rule.

### TECHNICAL FIELD

This disclosure generally relates to cloud computing services, and more specifically to rule-based cross-tenancy event delivery using cloud computing services.

### BACKGROUND

An entity, such as an organization that provides cloud computing services, may want to access resources in other tenancies or share resources with another entity within its own tenancy. The other entity may be another business unit in the cloud computing organization, a customer of the cloud computing organization, or a company that provides services to the cloud computing organization. In such cases, measures need to be taken to prevent the other entity from gaining unauthorized access to data or resources belonging to the organization.

### BRIEF DESCRIPTION OF THE DRAWINGS

FIG. 1 illustrates a system for event-driven dataflow integration for machine learning (ML) pipelines, according to at least one embodiment.

FIG. 2 illustrates a workflow for event-driven dataflow integration for ML pipelines, according to at least one embodiment.

FIG. 3 illustrates a flowchart for creating an ML pipeline run, according to at least one embodiment.

FIG. 4 illustrates a flowchart for deleting an ML pipeline run, according to at least one embodiment.

FIG. 5 illustrates a flowchart for changing an ML pipeline run, according to at least one embodiment.

FIG. 6 illustrates a flowchart for managed rule access policies, according to at least one embodiment.

FIG. 7 illustrates a block diagram illustrating a pattern of an Infrastructure as a Service (IaaS) architecture, according to at least one embodiment.

FIG. 8 illustrates a block diagram illustrating another pattern of an IaaS architecture, according to at least one embodiment.

FIG. 9 illustrates a block diagram illustrating another pattern of an IaaS architecture, according to at least one embodiment.

FIG. 10 illustrates a block diagram illustrating another pattern of an IaaS architecture, according to at least one embodiment.

FIG. 11 illustrates an example computer system, in which various embodiments may be implemented.

### DESCRIPTION OF EXAMPLE EMBODIMENTS

### Overview

According to an embodiment, a non-transitory computer-readable medium includes instructions that are configured, when executed by a processor, to perform operations. The operations include receiving from a service executing in a service tenancy and by an event broker a request to modify a rule to deliver a set of events from a first tenancy to the service tenancy. Modify includes at least one of create or update. The operations also include receiving from the service and by the event broker a proxy token for substantiating the request. The proxy token represents an authority of a user principal of the first tenancy. The operations further include determining, by the event broker, whether modification of the rule is authorized based at least on the authority of the user principal, and subsequent to determining that the modification of the rule is authorized, delivering, by the event broker, the set of events from the first tenancy to the service tenancy according to the rule.

In certain embodiments, the service is an ML pipeline service. In some embodiments, the first tenancy is a secure and isolated partition within an infrastructure of the event broker.

In certain embodiments, the authority of the user principal is based at least on an access policy that permits the user principal to inspect the set of events in the first tenancy. In some embodiments, the authority of the user principal is based at least on an access policy that permits the user principal to manage rules in the first tenancy.

In certain embodiments, the authority of the user principal is based at least on a cross-tenancy access policy pair that permits the user principal to modify the rule. The cross-tenancy access policy pair may include an endorse rule in the service tenancy and an admit rule in an events tenancy. The event broker may execute in the events tenancy.

In some embodiments, the proxy token is associated with one or more characteristics including: has an expiry time; or is revocable by the user principal prior to the expiry time.

In certain embodiments, the request to modify the rule includes a condition string. The rule may include the condition string, and/or the condition string may be used to match the set of events to a particular type of event. In certain embodiments, the request to modify the rule includes a pipeline stream identifier. The pipeline stream identifier identifies a pipeline stream. In some embodiments, the event broker delivers, in accordance with the rule, the set of events to the pipeline stream within the service tenancy in accordance with the pipeline stream identifier. In certain embodiments, the set of events are delivered to the pipeline stream in real time. In some embodiments, the pipeline stream is owned and managed by the service.

In certain embodiments, the operations further include receiving from the service and by the event broker a request to update the rule. The request to update the rule may include an identifier for the rule.

In some embodiments, the operations further include deleting, by the event broker, the rule in response to determining that the rule is not associated with any pipeline runs in progress.

In certain embodiments, the set of events represents a set of dataflow run events. Each dataflow run event of the set of dataflow run events may include a tag. The tag may be used to filter its respective dataflow run event such that the event broker only delivers a subset of dataflow run events from the set of dataflow run events that are created by the service to the service tenancy. In some embodiments, the tag is generated as part of creation of its respective dataflow run event.

In some embodiments, the rule is associated with a rule identifier and a pipeline run compartment identifier. The rule identifier and/or the pipeline run compartment identifier may be stored in a rule bucket. In certain embodiments, the rule bucket is not accessible by the first tenancy.

According to another embodiment, a system includes one or more processors and a non-transitory computer-readable medium including instructions that are configured, when executed by the one or more processors, to perform operations. The operations include receiving from a service executing in a service tenancy and by an event broker, a request to modify a rule to deliver a set of events from a first tenancy to the service tenancy. Modify may include at least one of create or update. The operations also include receiving from the service and by the event broker, a proxy token for substantiating the request. The proxy token represents an authority of a user principal of the first tenancy. The operations further include determining, by the event broker, whether modification of the rule is authorized based at least on the authority of the user principal, and subsequent to determining that the modification of the rule is authorized, delivering, by the event broker, the set of events from the first tenancy to the service tenancy according to the rule.

According to yet another embodiment, a method includes receiving from a service executing in a service tenancy and by an event broker a request to modify a rule to deliver a set of events from a first tenancy to the service tenancy. Modify may include at least one of create or update. The method also includes receiving from the service and by the event broker, a proxy token for substantiating the request. The proxy token represents an authority of a user principal of the first tenancy. The method further includes determining, by the event broker, whether modification of the rule is authorized based at least on the authority of the user principal, and subsequent to determining that the modification of the rule is authorized, delivering, by the event broker, the set of events from the first tenancy to the service tenancy according to the rule.

Technical advantages of certain embodiments of this disclosure may include one or more of the following. ML applications rely heavily on dataflow to process large data sets and prepare training data. Typically, the data processing step is one of several steps in the workload that implements the entire use case and orchestrates ingestions, transformations, and trainings. ML applications rely on ML pipelines for the orchestration and execution of these workloads. Certain embodiments described herein add one or more dataflow steps in the ML pipelines, which increases the ML applications'efficiency in their time taken to develop and orchestrate solutions.

Certain embodiments described herein adhere to strict security requirements while reducing the friction for a customer consuming cross-tenancy events. For example, certain embodiments utilize a user principal that has certain privileges (e.g., permission to inspect compartments, permission to create rules, etc.) granted to it by the customer.

The systems and methods of this disclosure may include an event service that provides a managed, scalable, and durable solution for ingesting and consuming high-volume data streams in real time. In certain embodiments, the event service may allow the user (e.g., a customer) to subscribe to changes in their resources and react to them automatically. Certain embodiments integrate a pipeline service and/or an event broker service with the event service to provide more control to the user to track resource changes and respond to these changes.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

The embodiments disclosed herein relate to event-driven dataflow integration for a pipeline. Pipelines typically require an extensive series of steps before they can be deployed to production. These steps may include one or more of the following: a data acquisition and extraction step, a data preparation step, a featurization step, an algorithm selection and hyperparameter tuning step for a model (e.g., a training model), a model evaluation step, a deployment step of the model, a monitoring step the deployed model, and a retraining step when required. Pipelines may be used to define and orchestrate these steps to make them understandable, executable, and reproducible by the pipeline's users.

A machine learning (ML) pipeline service is typically initially launched with each pipeline step corresponding to an ML job. For example, customers may wire each of their ML jobs to a pipeline step and orchestrate the pipeline steps as a workflow. The embodiments described herein include an addition to existing ML pipeline services called a dataflow step. The dataflow step allows users (e.g., customers) to configure their dataflow jobs (e.g., Apache Spark jobs) into pipeline steps. The addition of the dataflow step caters to the data acquisition and preparation aspects of the ML workflow.

In certain embodiments, for customer-owned dataflow jobs, the ML pipeline service uses a mechanism to consume a dataflow run's life-cycle events so that the pipeline runs can transition to subsequent steps or terminate accordingly. Since the dataflow job is customer-owned and is run inside the customer's tenancy, the event service publishes the corresponding life-cycle events (e.g., Mon-2: Run Begin and Run End events) to the user's tenancy. This disclosure describes embodiments for consuming cross-tenancy (user) events for dataflow runs.

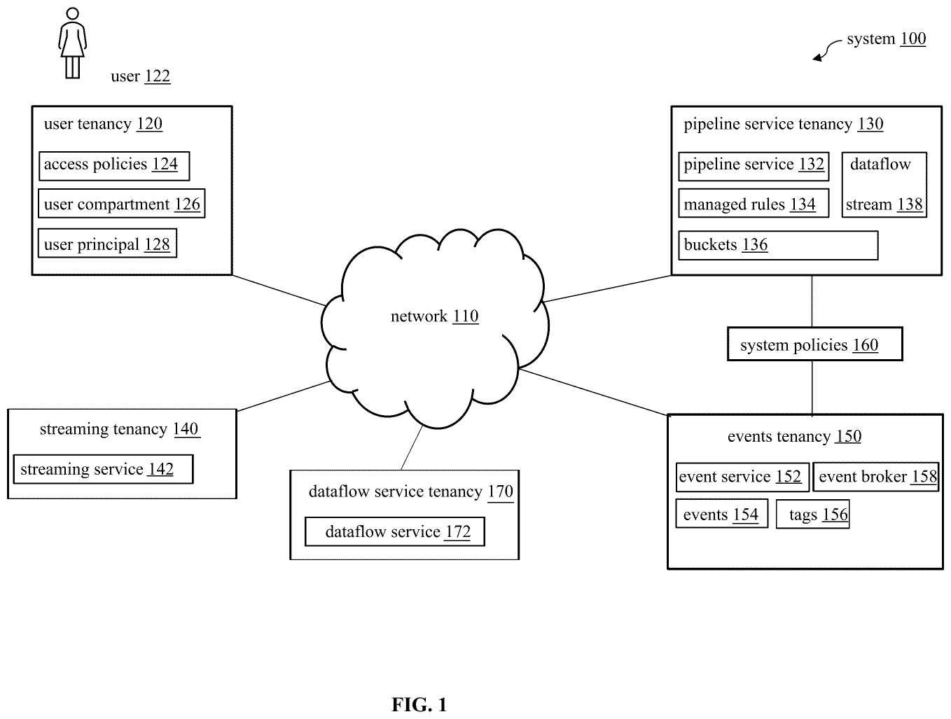

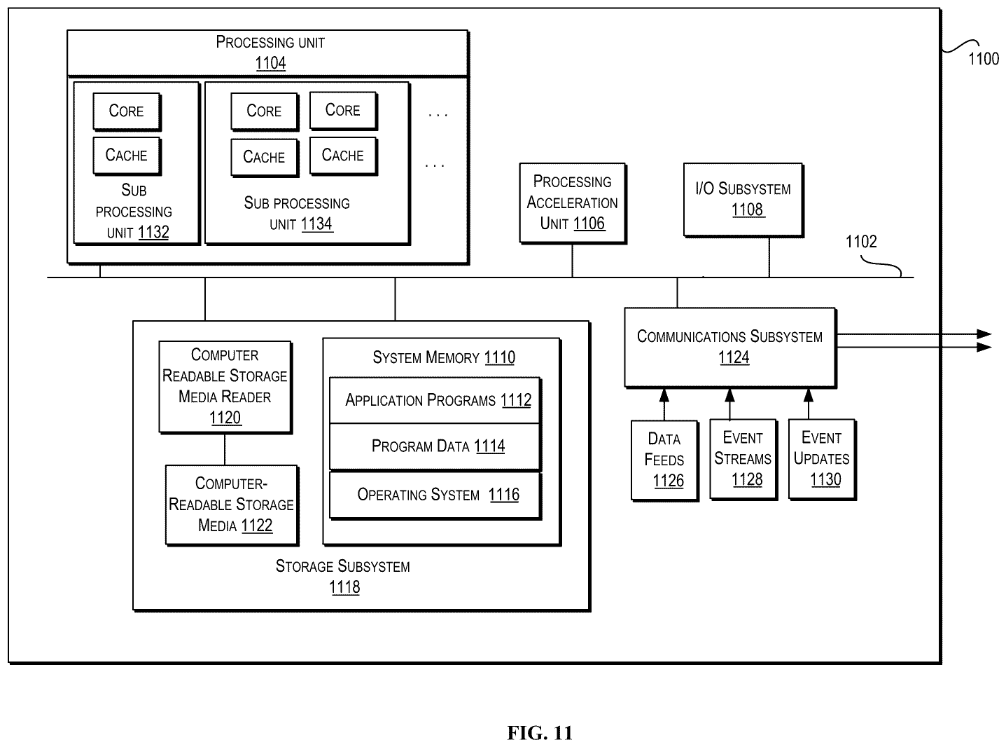

FIG. 1 illustrates a system 100 for event-driven dataflow integration for ML pipelines, according to at least one embodiment. System 100 or portions thereof may be associated with an entity, which may include any entity, such as a business or company, that integrates event-driven dataflow for ML pipelines. The components of system 100 may include any suitable combination of hardware, firmware, and software. For example, the components of system 100 may use one or more elements of the computer system of FIG. 11. System 100 includes a network 110, a user tenancy 120, a pipeline service tenancy 130, a streaming tenancy 140, an events tenancy 150, and a dataflow service tenancy 170.

Network 110 of system 100 represents any type of network that facilitates communication between components of system 100. One or more networks of system 100 may connect one or more components of system 100. One or more portions of any network of system 100 may include a cloud network, a private network, a public network, an ad-hoc network, a connection through the Internet, an intranet, an extranet, a virtual private network (VPN), a local area network (LAN), a wireless LAN (WLAN), a wide area network (WAN), a wireless WAN (WWAN), a Wi-Fi network, a mobile network, a metropolitan area network (MAN), a personal area network (PAN), a portion of the Internet, a portion of the Public Switched Telephone Network (PSTN), a cellular telephone network, a combination of two or more of these, or other suitable types of networks.

User tenancy 120 of system 100 represents a logical container for cloud resources of user 122. In certain embodiments, user tenancy 120 is a root container where user 122 can create, organize, and/or administer their cloud resources. User 122 associated with user tenancy 120 represents an entity, such as an organization, person, partner, or partner contact, that a business conducts business with. In certain embodiments, user 122 is a customer of pipeline service 132, event service 152, and/or event broker 158. In some embodiments, user tenancy 120 is a secure and isolated partition within an infrastructure of event broker 158.

Access policies 124 of user tenancy 120 represent policies that specify a set of permissions for user principal 128. In certain embodiments, access policies 124 are provided (e.g., authored, written, created, etc.) by user 122 against user principal 128. In some embodiments, access policies 124 allow pipeline service 132 to modify (e.g., create, update, etc.) managed rules 134, inspect user compartments 126, and the like. If user 122 has not provided the necessary access policies 124, pipeline service 132 can fail pipeline runs from starting. User compartment 126 represents a collection of related cloud resources within user tenancy 120. In certain embodiments, user tenancy 120 serves as a root compartment.

User principal 128 of user tenancy 120 represents an abstract representation of an identity. For example, after user 122 is successfully authenticated, user principal 128 can be associated with user 122 to add an extra identity to user 122. Authorization decisions can then be made based on user principal 128. In certain embodiments, user principal 128 allows pipeline service 132 to modify managed rules in one or more user tenancies 120 and/or user compartments 126. In some embodiments, user principal 128 provides pipeline service 132 inspect permissions one or more user tenancies 120 and/or user compartments 126.

In certain embodiments, user principal 128 uses a proxy token (e.g., an on-behalf-of token) to perform tasks on behalf of user 122. The proxy token is a token that allows for the secure exchange of data between different tenancies. In certain embodiments, the proxy token has an expiry time. In some embodiments, the proxy token is revocable by user principal 128 prior to the expiry time.

Pipeline service tenancy 130 of system 100 represents a logical container for cloud resources of pipeline service 132. In certain embodiments, pipeline service 132 represents a fully managed, serverless, cloud-based service. The network topology of pipeline service 132 may be an IaaS type cloud computing model, a Platform as a Service (PaaS) cloud computing model, or any other suitable type of topology.

Pipeline service 132 may include one or more of the following services: a data integration service, a job pipelines service, an ML pipeline service, a DevOps build pipeline service, and the like. The data integration service represents a cloud-based, serverless service that allows user 122 to create data pipelines to process data. The job pipelines service allows user 122 to define job dependencies and create a chain of builds. The ML pipelines service allows user 122 to define a workflow of tasks (e.g., data acquisition, model training, model evaluation, etc.) to create and serve an ML model. DevOps build pipelines service allows user 122 to create pipelines to deploy artifacts.

In certain embodiments, pipeline service 132 manages one or more pipelines. A pipeline is a sequence of steps that represent an ML process. A pipeline step represents an activity in the ML process (e.g., an input processing step, a training step, etc.). In some embodiments, the pipeline step is metadata that describes the step configuration. In certain embodiments, the pipeline step is created for a single dataflow application resource. The dataflow application may be an encapsulation of a Spark job (e.g., an Apache Spark job). A dataflow run represents a single run of a dataflow application. In certain embodiments, Directed Acyclic Graph (DAG) represents the dependencies between the ML pipeline steps.

In some embodiments, pipeline service 132 utilizes managed rules 134. Managed rules 134 allow pipeline service 132 to define cross-tenancy event rules and read audit data for compartments that they have permissions for. In certain embodiments, managed rules 134 allow pipeline service 132 to read audit events 154 that match defined rule conditions. For example, when audit event 154 matches a condition specified by managed rule 134, audit event 154 is delivered (e.g., pushed) to pipeline service dataflow stream 138 of pipeline service 132. In certain embodiments, the action for these managed rules 134 is configured such that event broker 158 delivers (e.g., continuously pushes) matching events 154 into pipeline service dataflow streams 138 owned and/or managed by pipelines service 132.

In certain embodiments, managed rules 134 apply to a specific user compartment 126 but are managed by pipeline service 132 and stored in pipeline service tenancy 130. In some embodiments, managed rules 134 are hidden rules. For example, managed rules 134 that are created by pipeline service 132 may only be visible to pipeline service 132 and may not be visible to user 122. In some embodiments, pipeline service 132 creates one managed rule 134 per target compartment, where the target compartment refers to a compartment of the pipeline run. Each compartment may only have one managed rule 134. One managed rule 134 may only apply to one user 122 and one user compartment 126. In some embodiments, only pipeline service dataflow stream 138 is supported as an event delivery destination. Changes to managed rules 134 may take effect within a predetermined amount of time (e.g., 5 seconds).

In some embodiments, pipeline service 132 programmatically creates (allow-listed) managed rules 134 at runtime. As a pre-requisite, user 122 may generate access policies 124 against their user principal 128 that allow pipeline service 132 to create managed rules 134 for user compartment 126. Given that the creation of managed rules 134 happens at runtime, the creation of managed rules 134 can be tightly scoped to only those users 122 who trigger pipeline runs with dataflow steps. Pipeline service 132 can fail pipeline runs from starting if user 122 has not provided the necessary access policies 124. Managed rules 134 may be created by pipeline service 132 as part of a create pipeline run workflow to avoid introducing additional latency for the create pipeline run API since it involves checking if managed rule 134 exists and then creating managed rule 134. In certain embodiments, managed rule 134 is created only if: (1) at least one step of type dataflow exists in the pipeline run; and (2) managed rule 134 does not already exist for that compartment.

In certain embodiments, pipeline service 132 generates a tag 156 as part of creation of its respective run event 154. Tags 156 are used to filter specific event types (e.g., dataflow events) such that event broker 158 only pushes a subset of run events 154 from the set of run events 154 that are created by pipeline service 132 to pipeline service tenancy 130. Filters may be specified to subscribe to required event types (e.g., dataflow events). An example managed rule 134 that may be created with a tag is as follows: (1) for all dataflow. run. begin and dataflow. run. end event types for dataflow runs; and (2) with freeform tags “freeformTags”: {“created_by”:“pipeline_service”} that act as a filter to filter only dataflow runs created by pipeline service 132.

Managed rules 134 may be associated with one or more of the following: a rule identifier (e.g., the identifier of managed rule 134 that is created); a compartment identifier (e.g., a pipeline run compartment identifier that may also serve as a composite key); a pipeline run identifier (e.g., an identifier of the pipeline run that created managed rule 134); a condition string (e.g., the condition string of managed rule 134, which may be used to filter events 154); a stream identifier (e.g., an identifier of the stream; and an event type (e.g., an enum that describes the type of event 154, such as a dataflow event). In some embodiments, the compartment identifier and the event type will serve as a composite key and hence will have an index (e.g., a unique constraint) created on it by default.

In certain embodiments, pipeline service 132 uses buckets 136 to store objects in a compartment within an object storage namespace. For example, pipeline service 1321 may create a managed rule bucket to store managed rules 134. The managed rule bucket may be used to store rule identifiers, pipeline run identifiers, and the like that are associated with managed rules 134. In certain embodiments, pipeline service 132 queries the managed rule bucket to check for any existing managed rule 134 in the pipeline run compartment.

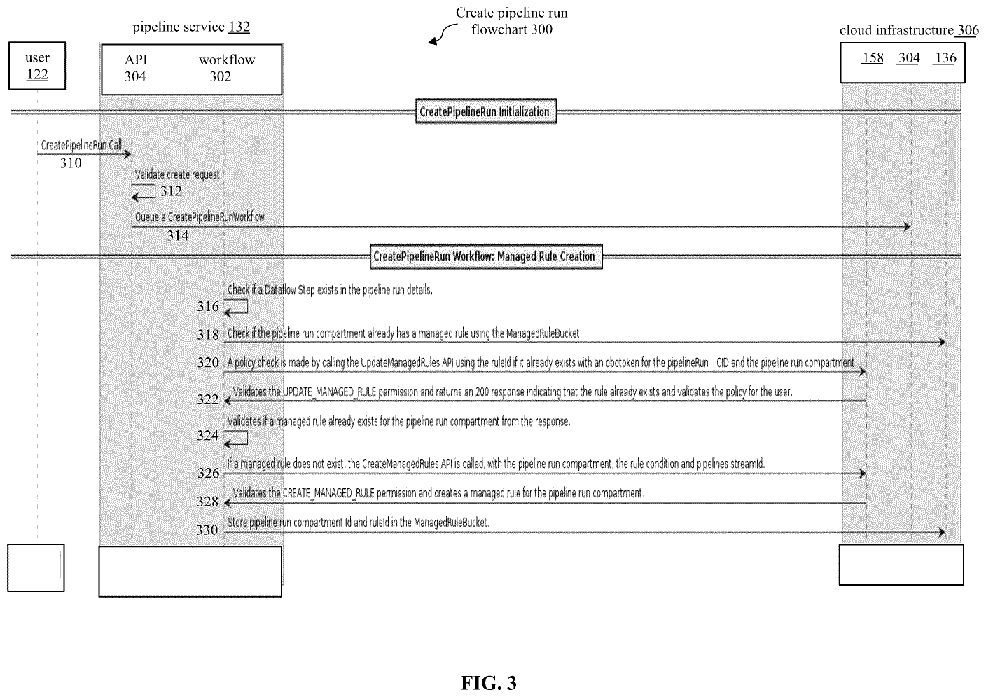

When user 122 creates multiple pipeline runs spanning hierarchical compartments, duplicate overlapping managed rules 134 may result in duplicate events 154 being delivered to dataflow stream 138. The lifecycle of managed rules 134 may be loosely coupled with that of a pipeline run. For example, managed rule 134 may be created when the first pipeline run with a dataflow step in a compartment is created. As another example, managed rule 134 may be deleted when a pipeline run is deleted and there are no other pipeline runs with a dataflow step in progress. In some embodiments, pipeline service 132 performs create, read, update and delete (CRUD) operations on managed rules 134 via APIs of event broker 158. The operations associated with the CRUD of managed rule 134 are detailed in FIGS. 3 through 6 below.

Given pipeline runs are workflow orchestrations, each pipeline needs to understand “when” to transition and “what” to transition to. For the ML job step type, pipeline service 132 may determine “when” to transition by listening to stream events 154 on the job run bucket for lifecycle status changes and transitioning the pipeline run status accordingly. This is possible when pipeline service 132 and event service 152 are both part of the same control plane. Pipeline service 132 provides “what” to transition to as input DAG at the pipeline resource creation time.

For dataflow runs managed by user 122, pipeline service 132 may use a mechanism to consume a dataflow run's lifecycle changes so that the pipeline runs can transition between steps accordingly. In certain embodiments, pipeline service 132 polls a get run API. For example, dataflow service 172 may provide the get run API, which allows pipeline service 132 to query the status (e.g., the lifecycle state and/or lifecycle details) of a dataflow run. Dataflow service tenancy 170 of system 100 represents a logical container for cloud resources of dataflow service 172. In some embodiments, event service 152 publishes the corresponding audit events 154, which include the lifecycle state and/or lifecycle details (e.g., Mon-2: run.begin and run.end events), to user tenancy 120.

Streaming tenancy 140 of system 100 represents a logical container for cloud resources of streaming service 142. Events tenancy 150 of system 100 represents a logical container for cloud resources of event service 152, events 154, and/or event broker 158.

In certain embodiments, event service 152 emits events 154. Events 154 represent structured messages that indicate changes in resources. Event service 152 may emit events 154 for resources or data. For example, object storage may emit events 154 for buckets 136 and objects. In some embodiments, event service 152 emits different types of events 154 for resources, which are distinguished as event types. In the illustrated embodiment of FIG. 1, event service 152 is interested in dataflow events (e.g., dataflow.run.begin and dataflow.run.end events).

In certain embodiments, event broker 158 of events tenancy 150 is a service (e.g., an internal cloud infrastructure service) that assists in the delivery of cross-tenancy audit events 154 to internal teams' streaming service 142. Event broker 158 may have a similar architecture as event service 152, where rules can be created using their APIs to gain access to required events 154. In some embodiments, event broker 158 allows pipeline service 132 to create hidden managed rules 134. For example, pipeline service 132 may create managed rule 134 that allows the partner service team to define cross-tenancy event rules and read audit events for compartments that they have permissions to read events 154 of user 122.

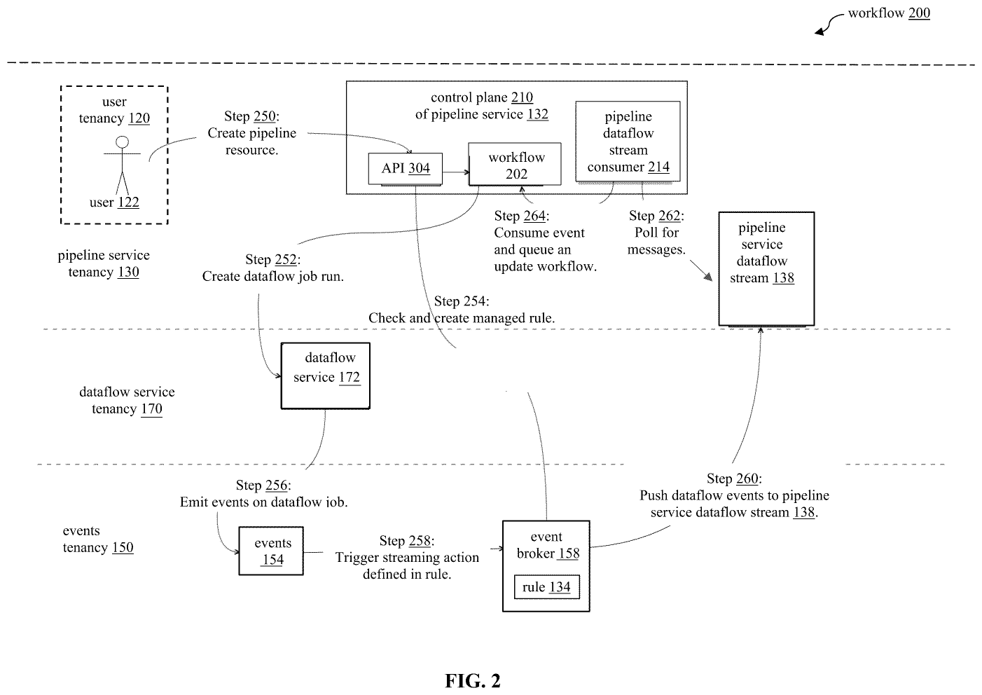

In certain embodiments, event broker 158 allows pipeline service 132 to move away from existing polling (pull) based design (cyclic workflow to poll dataflow runs), which may not scale up, to a push-based design. Pipeline service 132 can subscribe to the audit event types of interest, at a compartment level. Then, desired events 154 are delivered (e.g., pushed) into dataflow stream 138 owned by pipeline services 132 in (near) real time, as soon as they appear in event service 152. The pipeline dataflow stream consumer (see FIG. 2) can leverage this dataflow stream138 as its source for fetching customer's audit events 154, extracting the lifecycle state and lifecycle details from the events 154, and transitioning the step run and consequently the pipeline run.

In certain embodiments, event broker 158 is an extension of event service 152. Event broker 158 may have a different event and/or rule schema and dedicated infrastructure that is different from dataflow service 172. Event broker 158 may allow other cloud infrastructure services under the same umbrella to have hidden event rules (to read cross-tenancy customer events 154. In certain embodiments, event broker 158 can access events 154 of user 122. Event broker 158 may provide different types of rules for pipeline service 132 to access events 154 of user 122. For example, event broker 158 may create managed rules 134.

System policies 160 allow pipeline service 132 to define cross-tenancy event rules and read audit events 154 for one or more (e.g., all) compartments. System policies 160 are stored within event tenancy 150, which allows each system policy 160 to be used to read audit events 154 from multiple/all tenancies. In certain embodiments, one or more system policies 160 are created by event broker 158 that allow pipeline service 132 to access desired events 154 (e.g., dataflow run-begin and run-end events) in a plurality of user tenancies 120 and user compartments 126. In some embodiments, user 122 does not author system policies 160.

In certain embodiments, event broker 158 has a managed router and/or a forwarder that delivers (e.g., continuously pushes) one or more events 154 that match managed rule(s) 134 to a pre-registered stream (e.g., pipeline service dataflow stream 138 in pipeline service tenancy 130.

In operation, event broker 158 of events tenancy 150 receives from pipeline service 132 executing in pipeline service tenancy 130, a request to modify managed rule 134, where managed rule 134 is used to deliver a set of events 154 from a user tenancy 120 to pipeline service tenancy 130. The request to modify managed rule 134 may include a request to create managed rule 134, to update managed rule 134, and so forth. Event broker 158 then receives from pipeline service 132, a proxy token for substantiating the request, where the proxy token represents an authority of user principal 128 of user tenancy 120. Event broker 158 determines whether modification of managed rule 134 is authorized based at least on the authority of user principal 128. Subsequent to determining that the modification of managed rule 134 is authorized, event broker 158 delivers the set of events 154 from user tenancy 120 to pipeline service tenancy 130 according to managed rule 134. As such, by adding one or more dataflow steps in the ML pipelines, the ML applications' efficiency in their time taken to develop and orchestrate solutions is increased.

FIG. 2 illustrates a workflow 200 for event-driven dataflow integration for ML pipelines, according to at least one embodiment. Workflow 200 or portions thereof may be associated with an entity, which may include any entity, such as a business or company, that integrates dataflow for ML pipelines. The components of workflow 200 may include any suitable combination of hardware, firmware, and software. For example, the components of workflow 200 may use one or more elements of the computer system of FIG. 11.

Workflow 200 includes steps 250 through 264. At step 250 of workflow 200, user 122 of user tenancy 120 creates a pipeline resource. In certain embodiments, the pipeline resource includes one or more dataflow steps. At step 252, a pipeline run workflow 202 of pipeline service 132 creates a dataflow job run. For example, an API 304 of pipeline service 132 may validate a create request and queue a create_pipeline_run_workflow. Workflow 200 then moves to step 254, where API 304 of pipeline service 132 checks and creates a managed rule. For example, pipeline service 132 may first check to see if at least one dataflow step exists in the pipeline run details. If at least one dataflow step does exist in the pipeline run details, API 304 may query a managed rule bucket (managed rule bucket 136 of FIG. 1) to check if a managed rule (e.g., managed rule 134 of FIG. 1) exists for the pipeline run compartment. If a managed rule does not exist for the pipeline run compartment, pipeline service 132 makes a create managed rule call to event broker 158 of events tenancy 150. The create managed rule call may include the pipeline run compartment identifier, a condition string (used to match events 154) and/or a stream identifier (used to push matched events 154 to pipelines owned).

At step 256 of workflow 200, dataflow service 172 of dataflow service tenancy 170 emits events (e.g., run.begin and run.end events) on the dataflow job run in the user compartment (e.g., user compartment 126). Workflow 200 then moves to step 258, where the managed rule which was previously set up to allow dataflow events 154 triggers a steaming action in the defined managed rule. At step 260 of workflow 200, dataflow events 154 are pushed to pipeline service dataflow stream 138 of pipeline service tenancy 130. For example, event broker 158 may validate the create managed rule permission, validate that the user principal and proxy (e.g., on-behalf-of) context variable used to make the create managed rule call has access to push to pipeline service dataflow stream 138 as indicated in the request, and create a managed rule for the pipeline run compartment. Event broker 158 may then filter dataflow events 154 (e.g., run. begin and run. end events) and push filtered events 154 to pipeline service dataflow stream 138 in pipeline service tenancy 130.

At step 262 of workflow 200, pipeline dataflow stream consumer 214 polls for messages from pipeline service dataflow stream 138. For example, pipeline dataflow stream consumer 214 may use a cyclic workflow that polls pipeline service dataflow stream 138 at a predetermined time interval (e.g., every minute). At step 264 of workflow 200, pipeline service 132 consumes events 154 from the pipeline service dataflow stream 138 and queues an update workflow. For example, pipeline service 132 may consume dataflow run audit events 154 from pipeline service dataflow stream 138 using the cyclic workflow that polls pipeline service dataflow stream 138, verifies that the dataflow run publishing audit events 154 in user tenancy 120 was created by a pipeline run which is currently in progress, and then proceed to update the lifecycle state of the pipeline step which triggered the dataflow run. This may happen in (near) real time, improving customer experience.

FIG. 3 illustrates a flowchart 300 for the creation of a pipeline run. Flowchart 300 includes actions performed by user 122, pipeline service 132, and cloud infrastructure 306. In the illustrated embodiment of FIG. 3, pipeline service 132 includes create pipeline run workflow 302 and API 204. Cloud infrastructure 306 represents a cloud computing service that may provide servers, storage, network, applications, and/or services through a global network of managed data centers. In the illustrated embodiment of FIG. 3, cloud infrastructure 306 includes event broker 158, workflow as a service (WaaS) 308, and buckets 136. WaaS 308 represents a service internal to cloud infrastructure 306 that is used to queue workflows.

Steps 310 through 314 of flowchart 300 are directed toward initialization of the pipeline run creation. At step 310, user 122 communicates a request to a create a pipeline run call to API 304 of pipeline service 132. At step 312, API 304 of pipeline service 132 validates the request to a create a pipeline run call, and at step 314, API 304 queues a create pipeline run workflow with WaaS 308.

Steps 316 through 330 of flowchart 300 are directed toward creating the pipeline run workflow and creating a managed rule (e.g., managed rule 134 of FIG. 1). At step 316, create pipeline run workflow 302 of pipeline service 132 validates the payload by checking to see whether at least one dataflow step exists in the pipeline run details. If at least one dataflow step exists in the pipeline run details, flowchart 300 moves to from step 316 to step 318, where create pipeline run workflow 302 queries managed rule bucket 136 to check if a managed rule already exists for the pipeline run compartment.

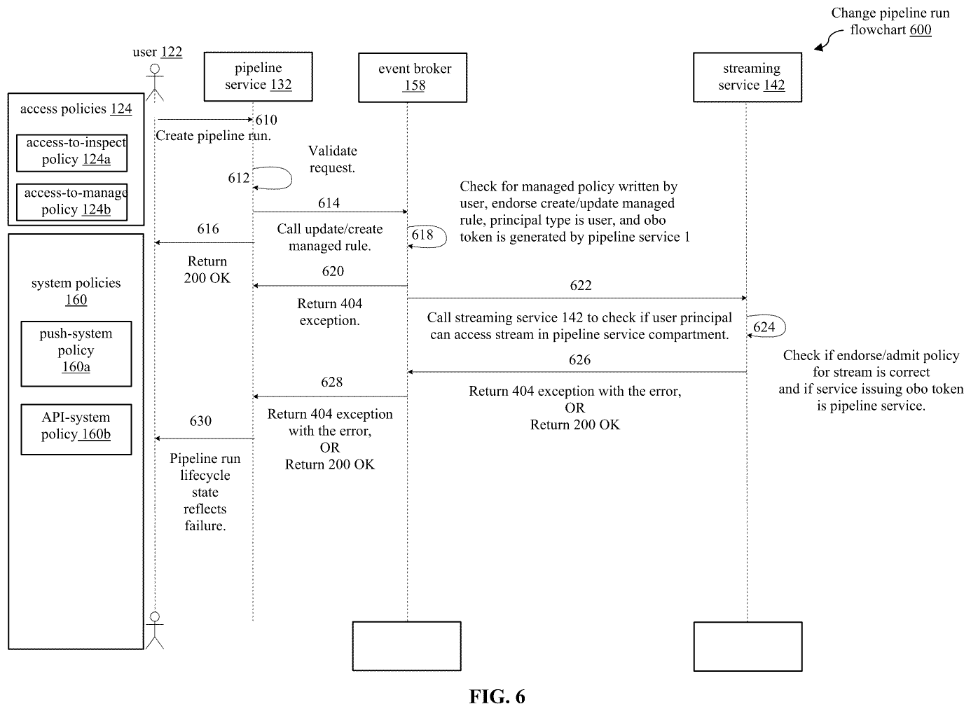

If a manage rule for the pipeline run compartment already exists, flowchart 300 moves to step 320, where create pipeline run workflow 302 performs a policy check by calling the update managed rules API of event broker 158 using the rule identifier (if the rule identifier exists) and a proxy (e.g., on-behalf-of) token. In certain embodiments, create pipeline run workflow 302 fetches the rule identifier from managed rule bucket 136. At step 322, event broker 158 validates the update managed rule permission and returns a response (e.g., a 200 response) indicating that the managed rule already exists. Event broker 158 also validates the access policy (e.g., access policy 124 of FIG. 1 or access-to-manage policy 124b of FIG. 6) for user 122. Flowchart 300 then moves from step 322 to step 324, where create pipeline run workflow 302 validates if the managed rule already exists for the pipeline run compartment from the response.

If, at step 324, a managed rule does not exist (e.g., the update managed rule call fails with a 404 error), then flowchart 300 moves from step 324 to step 326, where a create managed rule call is made to event broker 158 with the pipeline run compartment identifier, a condition string (used to match events) and a stream identifier (used to push matched events to pipelines owned). At step 328, event broker 158 validates the create managed rule permission, validates that the principal and proxy token (e.g., obo context variable) used to make the create managed rule call has access to push to the stream in the request, and creates a managed rule for the pipeline run compartment. At step 330, create pipeline run workflow 302 stores the pipeline run compartment identifier and the managed rule identifier in managed rule bucket 136. In certain embodiments, managed rule bucket 136 is updated by replacing the old rule identifier used to make the update managed rule call with the new rule identifier received in the create managed rule call's response.

In the case of parallel create pipeline run calls with at least one dataflow step, there is a race condition to create a managed rule. If multiple managed rules of event type dataflow are created, the subsequent calls to store the pipeline run compartment identifier and the managed rule identifier in managed rule bucket 136 will generate a duplicate key exception.

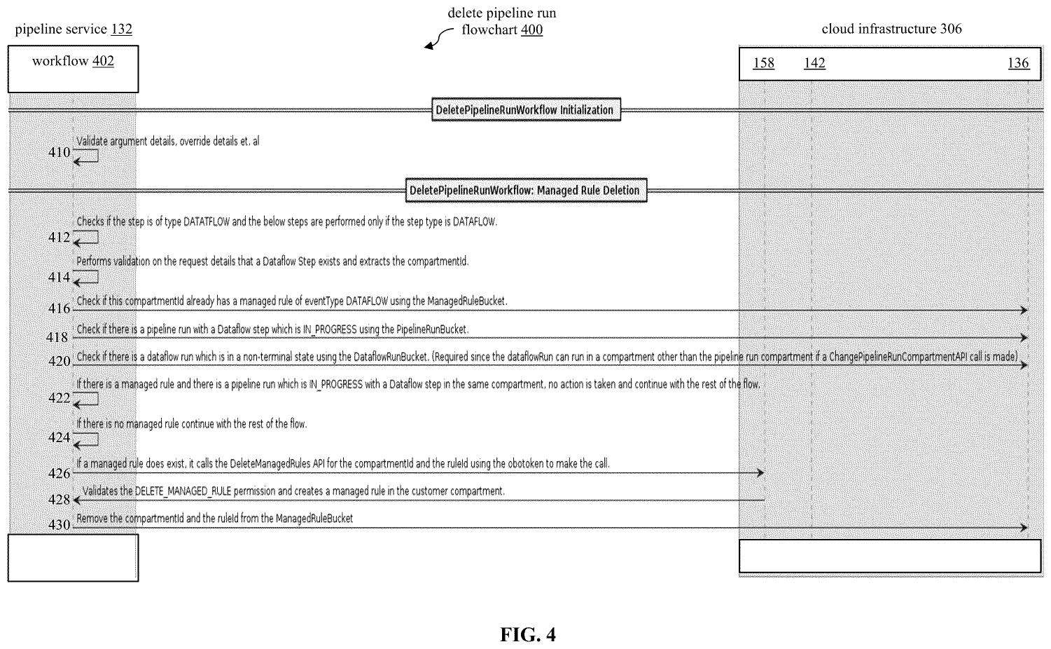

FIG. 4 illustrates a flowchart 400 for the deletion of a pipeline run. Flowchart 400 includes actions performed by pipeline service 132 and cloud infrastructure 306. In the illustrated embodiment of FIG. 4, pipeline service 132 includes delete pipeline run workflow 402. Cloud infrastructure 306 includes event broker 158, event service 152, and buckets 136.

Steps 410 of flowchart 400 is directed toward initialization of the pipeline run deletion. During the initialization of the pipeline run deletion, the user deletes a pipeline run with one or more dataflow steps. The API of pipeline service 132 validates the create pipeline workflow request and queues delete pipeline run workflow 402. At step 410 of flowchart 400, delete pipeline run workflow 402 validates the details (e.g., argument details, override details, etc.) of the delete pipeline run workflow request.

Steps 412 through 430 of flowchart 400 are directed toward deleting the pipeline run workflow and deleting the managed rule (e.g., managed rule 134 of FIG. 1). At step 412 of flowchart 400, delete pipeline run workflow 402 checks whether the pipeline step is a dataflow step. If the pipeline step is not a dataflow step, flowchart 400 ends. If the pipeline step is a dataflow step, flowchart 400 proceeds to step 414. At step 414 of flowchart 400, delete pipeline run workflow 402 performs validation on the request details that a dataflow step exists. In certain embodiments, delete pipeline run workflow 402 extracts the compartment identifier.

At step 416 of flowchart 400, delete pipeline run workflow 402 queries managed rule bucket of buckets 136 of cloud infrastructure 306 to determine whether a managed rule exists for the pipeline run compartment. If a managed rule does exist for the pipeline run compartment, flowchart 400 proceeds to step 418. If a managed rule does not exist for the pipeline run compartment, flowchart 400 advances to step 422.

At step 418, delete pipeline run workflow 402 queries a pipeline run bucket of buckets 136 to determine whether a pipeline run with a dataflow step exists for the pipeline run compartment and is in progress. If a pipeline run with a dataflow step is in progress, flowchart 400 proceeds to step 420. If a pipeline run with a dataflow step is not in progress, flowchart 400 advances to step 422.

At step 420 of flowchart 400, delete pipeline run workflow 402 queries the dataflow run bucket of buckets 136 to determine whether a dataflow run exists for the pipeline run compartment and is in a non-terminal state using the dataflow run bucket of buckets 136. In certain embodiments, the dataflow run may run in a compartment other than the pipeline run compartment if a change pipeline run compartment API call is made. If a dataflow run exists for the pipeline run compartment that is in a non-terminal state, flowchart 400 proceeds to step 422.

At step 422 of flowchart, if a managed rule exists (see step 416) and the pipeline run is in progress (see step 418) with a dataflow step in the same compartment, then no action is taken and flowchart 400 continues with the rest of the flow. Otherwise, flowchart 400 advances to step 424. If, at step 424, there is no managed rule (see step 418), flowchart 400 continues with the rest of the flow. Otherwise, flowchart 400 advances to step 426. If, at step 426, a managed rule does exist, delete pipeline run workflow 402 calls the delete managed rule API of event broker 158 for the rule identifier and the compartment identifier. Delete pipeline run workflow 402 uses the proxy (e.g., on-behalf-of) token to make the call. Flowchart 400 then moves to step 428, where event broker 158 validates the delete managed rule permission and returns a response (e.g., a 200 response) and creates a managed rule in the user compartment. Flowchart 400 ends at step 430, where delete pipeline run workflow 402 of pipeline service 132 deletes the pipeline run compartment identifier and the managed rule identifier from the managed rule bucket of buckets 136.

In the case of parallel delete pipeline run calls with at least one dataflow step, there is a race condition to create a managed rule. If multiple managed rules are deleted, the subsequent call(s) will fail, and the exception will be handled.

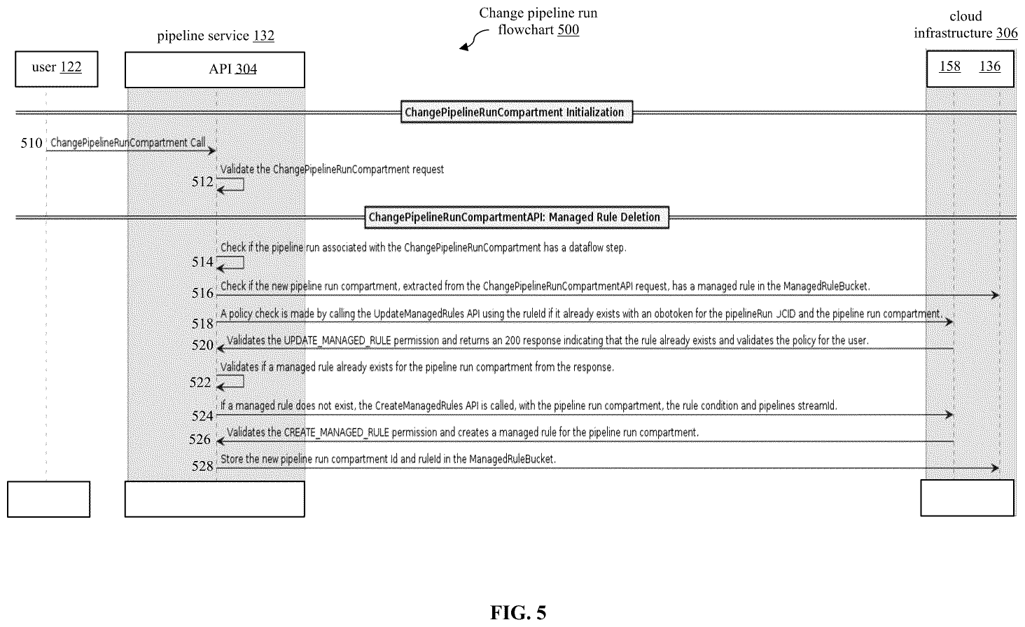

FIG. 5 illustrates a flowchart 500 for a change of a pipeline run. Flowchart 500 includes actions performed by user 122, pipeline service 132, and cloud infrastructure 306. In the illustrated embodiment of FIG. 5, pipeline service 132 includes API 304, and cloud infrastructure 306 includes event broker 158 and buckets 136.

Steps 510 through 512 are directed toward initialization of the pipeline run workflow change. At step 510, user 122 makes a change pipeline run compartment call to API 304 of pipeline service 132. At step 512, API 304 validates the change pipeline run compartment request.

Steps 514 through 528 of flowchart 500 are directed toward changing the pipeline run compartment API and deleting the managed rule. At step 514, API 304 validates the payload by checking to see whether a dataflow step exists in the pipeline run details associated with the change pipeline run compartment. If a dataflow step exists in the pipeline run details, then flowchart proceeds to step 516, where API 304 queries the managed rule bucket of buckets 136 to determine whether the new pipeline run compartment, extracted from the change pipeline run compartment API request, has a managed rule.

Flowchart 500 then moves to step 518, where API 304 makes a policy check by calling the update managed rules API of event broker 158 using the rule identifier fetched from the managed rule bucket (if the managed rule exists) for the pipeline run identifier and the pipeline run compartment. API 304 makes the call to event broker 158 using a proxy (e.g., on-behalf-of) token.

At step 520 of flowchart 500, event broker 158 validates the update managed rule permission and returns a response (e.g., a 200 response) indicating that the managed rule already exists and validates the access policy (e.g., access-to-manage policy 124b of FIG. 6) for user 122. Flowchart 500 then moves to step 522, where API 304 validates if a managed rule already exists for the pipeline run compartment based on the response.

At step 524 of flowchart 500, if a managed rule does not exist for the pipeline run compartment, a create managed rule call is made to event broker 158 with the pipeline run compartment identifier, the condition string (used to match events), and the pipeline stream identifier (used to push matched events to pipelines owned). At step 526, event broker 158 validates the create managed rule permission and creates a managed rule for the pipeline run compartment. At step 528, API 304 stores the pipeline run compartment identifier and the managed rule identifier in the managed rule bucket of buckets 136.

FIG. 6 illustrates a flowchart 600 for a change pipeline run compartment. Specifically, flowchart 600 represents an end-to-end managed rule flow for pipeline run CRUD operations. FIG. 6 illustrates a plurality of managed rule access policies. The managed rule access policies include access policies 124 added by user 122 and system policies 160. Flowchart 600 shows the policy checks made for the create managed rule call and the update managed rule call. The list (GET) and delete managed rule calls also include a check by event broker 158 on whether the user principal making the call can access the stream.

Access polices 124 are policies provided (e.g., authored, written, created, etc.) by user 122 (e.g., a customer) that grant pipeline service 132 rights to manage rules. Access policies 124 may include an access-to-inspect policy 124a and an access-to-manage policy 124b.

Access-to-inspect policy 124a provided by user 122 grants the user principal making managed rule API calls permission to inspect the compartment for which the managed rule is being modified (e.g., created or updated). For example, access-to-inspect policy 124a may permit the user principal to inspect the set of events (e.g., events 154 of FIG. 1) in the user tenancy's compartment. An example of access-to-inspect policy 124a located in the user tenancy (e.g., user tenancy 120 of FIG. 1) is as follows: “allow group pipeline_ service_users to inspect compartments in tenancy.”

Access-to-manage policy 124b provided (e.g., authored, written, created, etc.) by user 122 grants the user principal making managed rule API calls permission to manage (e.g., create, update, etc.) a managed rule on behalf of the owner of the compartment. For example, access-to-manage policy 124b may permit the user principal to modify the manage rules in the user's tenancy. An example of access-to-manage policy 124b located in the user tenancy is as follows: “allow group pipeline_ service_users to manage event rules in tenancy where all {target_rule_type=‘managed’, target_event_source in (‘dataflow’)}.

System policies 160 are managed rule access policies that are provided (e.g., authored, written, created, etc.) between pipeline service 132 and event broker 158. In certain embodiments, system policies 160 define cross-tenancy event rules and read audit events for one or more (or all) compartments. In some embodiments, system policies 160 are admit/endorse policies. System policies 160 may be stored within the event tenancy (e.g., event tenancy 150 of FIG. 1) since one or more system policies 160 may be used to read audit events from multiple/all tenancies. In certain embodiments, the principal used for system policies 160 is the user principal (e.g., user principal 128 of FIG. 1) using proxy (e.g., on-behalf-of) tokens. System policies 160 may include a push-system policy 160a and an API-system policy 160b.

Push-system policy 160a grants the user principal permission to push events to the stream mentioned in the managed rule. In certain embodiments, push-system policy 160a checks ownership of the stream. Push-system policy 160a may be a cross-tenancy access policy admit/endorse pair. For example, push-system policy 160a may include an endorse rule in the pipeline service tenancy and an admit rule in the event broker tenancy.

At pipeline service 132's end, the endorse rule of push-system policy 160a may define the tenancy of pipeline service 132, define the stream compartment of pipeline service 132, endorse certain users to use stream-push in the stream compartment of the tenancy of pipeline service 132, endorse certain users to read streams in the stream compartment, and so on. An example of push-system policy 160a at pipeline service 132's end is as follows: “define tenancy service_tenancy as tenancy.1; define compartment stream_compartment as compartment.1; endorse any-user to use stream-push in compartment stream_compartment of tenancy service_tenancy where all {request.obo-service.name=‘pipeline service’}; endorse any-user to read streams in compartment stream_compartment of tenancy service_tenancy where all {request.obo-service.name=‘pipeline service’}.

At event broker 158's end, the admit rule push-system policy 160a may define the tenancy of pipeline service 132, define the stream compartment of pipeline service 132, admit certain users to stream-push in the stream compartment of the pipeline service tenancy, admit certain users to read streams in the stream compartment, and so on. An example of push-system policy 160a at event broker 158's end is as follows: “define tenancy service_tenancy as tenancy.1; define compartment stream_compartment as compartment.1; admit any-user to use stream-push in compartment stream_compartment where all {request.obo-service.name=‘pipeline service’}; admit any-user to read streams in compartment stream_compartment where all {request.obo-service.name=‘pipeline service’}.

API-system policy 160b grants the user principal permission to use managed rule APIs. For example, API-system policy 160b may grant the user principal permission to perform general API access whitelisting on event broker 158. In certain embodiments, API-system policy 160b is used to facilitate cross-tenancy authorization using the user principal. In some embodiments, API-system policy 160b allows the user principal to modify (e.g., create, delete, update, etc.) the managed rule. In certain embodiments, API-system policy 160b is a cross-tenancy access policy pair that includes an endorse rule in the tenancy of pipeline service 132 and an admit rule in the tenancy of event broker 158.

At pipeline service 132's end, API-system policy 160b may define a tenancy, endorse certain users to create/update managed rules, endorse certain users to read/list/delete managed rules, and so on. An example API-system policy 160b at user 122's end may be as follows: “define tenancy events_prod_tenancy as ‘tenancy.1’; endorse any-user to {create_managed_rule, update_managed_rule} in tenancy events_prod_tenancy where all {target.service.id=‘tenancy.1’, target.event.source in (‘dataflow’), request.obo-service.name=‘pipeline service’}; endorse any-user to {read_managed_rule, list_managed_rules, delete_managed_rule} in tenancy events_prod_tenancy where all {target.service.id=‘tenancy.1’, request.obo-service.name=‘pipeline service’}.

At event service 132's end, API-system policy 160b may be added by onboarding the pipeline service tenancy (e.g., pipeline service tenancy 130 of FIG. 1) to event broker 158. API-system policy 160b may define a tenancy, endorse certain users to create/update managed rules, endorse certain users to read/list/delete managed rules, and so on. An example API-system policy 160b at event service 132's end may be as follows: “admit any-user to {create_managed_rule, update_managed_rule} in tenancy where all {target.service.id=‘tenancy.1’, request.obo-service.name=‘pipeline service’, target.event.source in (‘dataflow’)}; admit any-user to {read_managed_rule, list_managed_rules, delete_managed_rule} in tenancy where all {target.service.id=‘tenancy.1’, request.obo-service.name=‘pipeline service’}.

Flowchart 600 of FIG. 6 includes actions performed by user 122, pipeline service 132, event broker 158, and streaming service 142. Flowchart 600 of FIG. 6 includes steps 610 through 630. At step 610, user 122 creates a pipeline run call with one or more dataflow steps. At step 612, pipeline service 132 validates the create request. Flowchart them moves from step 612 to step 614, where pipeline service 132 makes a call to event broker 158 to update a managed rule or to create a managed rule. At step 616, pipeline service 132 returns a response (e.g., a 200 response) to user 122.

At step 618 of flowchart 600, event broker 158 checks for access-to-manage policy 124b written by user 122. Event broker 158 also checks the endorse create managed rule or endorse update managed rule of API-system policy 160b. Event broker 158 further checks whether the principal type is user 122 and whether the proxy (e.g., on-behalf-of) token is generated by pipeline service 132 in the corresponding endorse create managed rule or endorse update managed rule of API-system policy 160b written for each endorse rule for the events.

At step 620 of flowchart 400, event broker 158 returns a 404 exception if the update managed rule call fails. At step 622, for create managed rule and update managed rule calls, a call is made to streaming service 142 to check if user principal 128 can access the stream in the pipeline service compartment mentioned in the body of the request. At step 624, streaming service 142 checks if the endorse policy and the corresponding admit policy for the stream is correct and if the service issuing the obo token is pipeline service 132. At step 626, if the endorse policy and the corresponding admit policy of API-system policy 160b for the stream is correct and if the service issuing the obo token is pipeline service 132, streaming service 142 communicates a return ok (e.g., a return 200 ok) to event broker 158. Otherwise, streaming service 142 communicates a return 404 exception with an error stating that action of type streaming service is not authorized, and that the stream identifier does not exist or streaming service 142 does not have access to the stream identifier.

At step 628, event broker 158 returns either the 404 exception with the error or the return 200 OK, depending on whether or not the endorse policy and the corresponding admit policy of system policies 160 for the stream is correct and if the service issuing the obo token is pipeline service 132. At step 630, the pipeline run lifecycle state reflects the failure.

Particular embodiments may repeat one or more steps of workflow 200 of FIG. 2 and/or flowcharts 300, 400, 500, and/or 600 of FIGS. 3, 4, 5, and 6, respectively, where appropriate. Although this disclosure describes and illustrates particular steps of workflow 200 and flowcharts 300, 400, 500, and 600 as occurring in a particular order, this disclosure contemplates any suitable steps of workflow 200 and/or flowcharts 300, 400, 500, and/or 600 occurring in any suitable order. Moreover, although this disclosure describes and illustrates example workflows and flowcharts, this disclosure contemplates any suitable workflows and/or flowcharts, including any suitable steps, which may include all, some, or none of the steps of workflow 200 and flowcharts 300, 400, 500, and 600, where appropriate. Furthermore, although this disclosure describes and illustrates particular components, devices, or systems carrying out particular steps of workflow 200 and flowcharts 300, 400, 500, and 600, this disclosure contemplates any suitable combination of any suitable components, devices, or systems carrying out any suitable steps of workflow 200 and flowcharts 300, 400, 500, and 600.

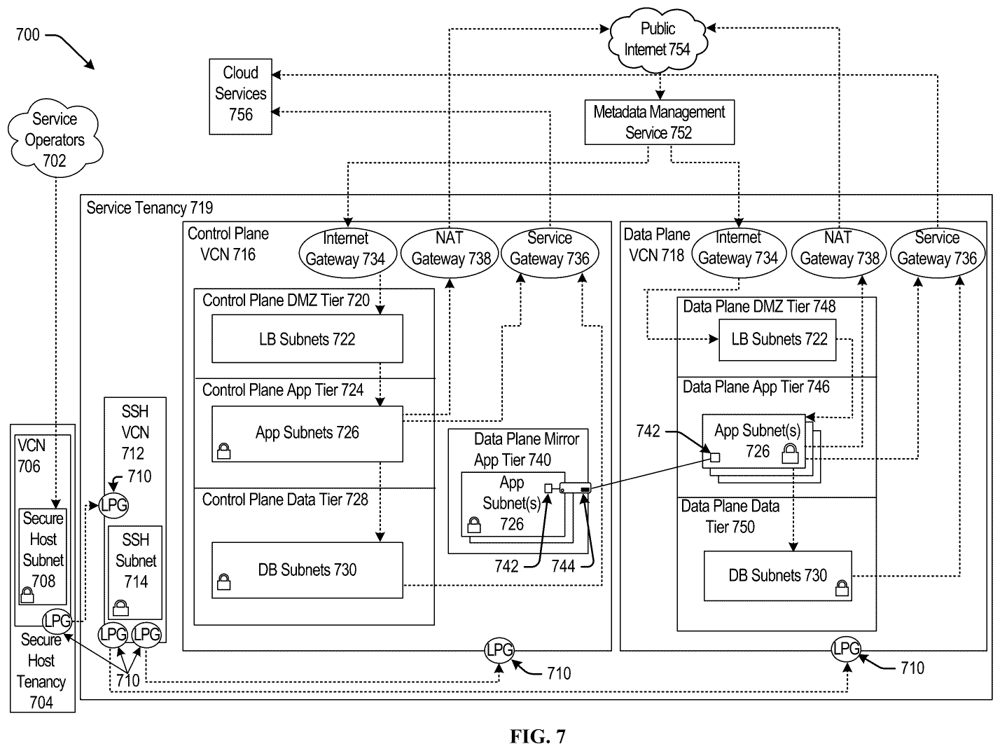

FIG. 7 is a block diagram 700 illustrating an example pattern of an IaaS architecture, according to at least one embodiment. Service operators 702 can be communicatively coupled to a secure host tenancy 704 that can include a VCN 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user (e.g., a customer) of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users from interacting with other users' resources. Also, this embodiment may allow users of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

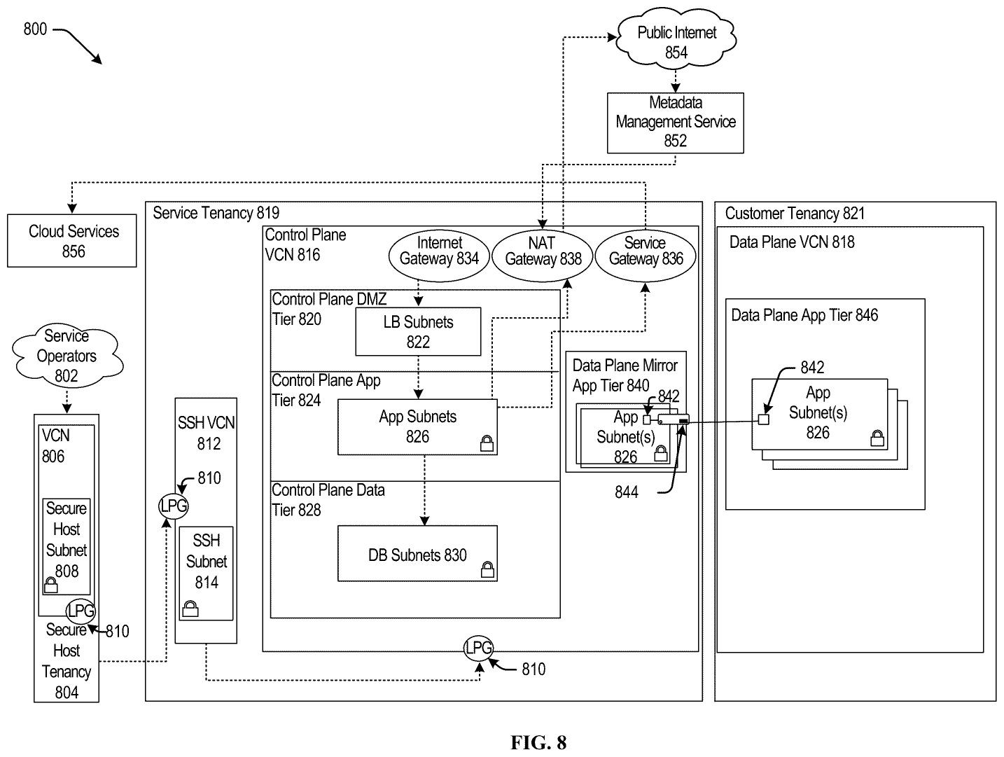

FIG. 8 is a block diagram 800 illustrating another pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a VCN 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 810 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, which are provisioned in the control plane VCN 816 that is contained in the service tenancy 1019, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 1021, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 6,” may be located in Region 1 and in “Region 2.” If a call to Deployment 6 is made by the service gateway 836 contained in the control plane VCN 816 located in Region 1, the call may be transmitted to Deployment 6 in Region 1. In this example, the control plane VCN 816, or Deployment 6 in Region 1, may not be communicatively coupled to, or otherwise in communication with, Deployment 6 in Region 2.

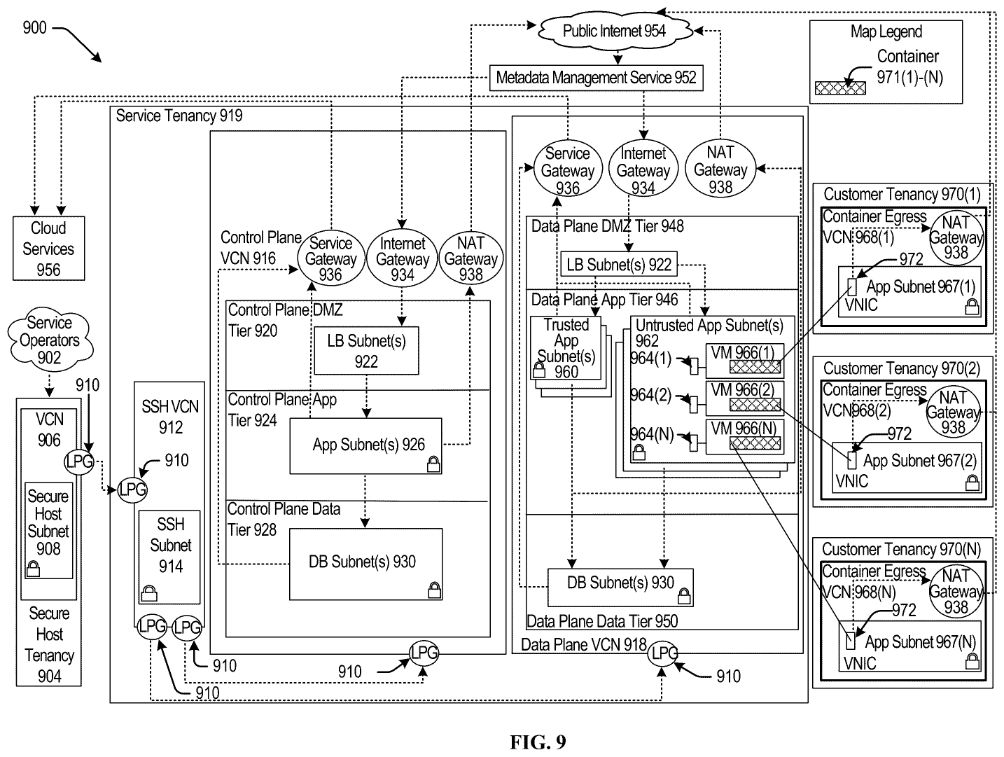

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a VCN 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane VCN 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management service 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

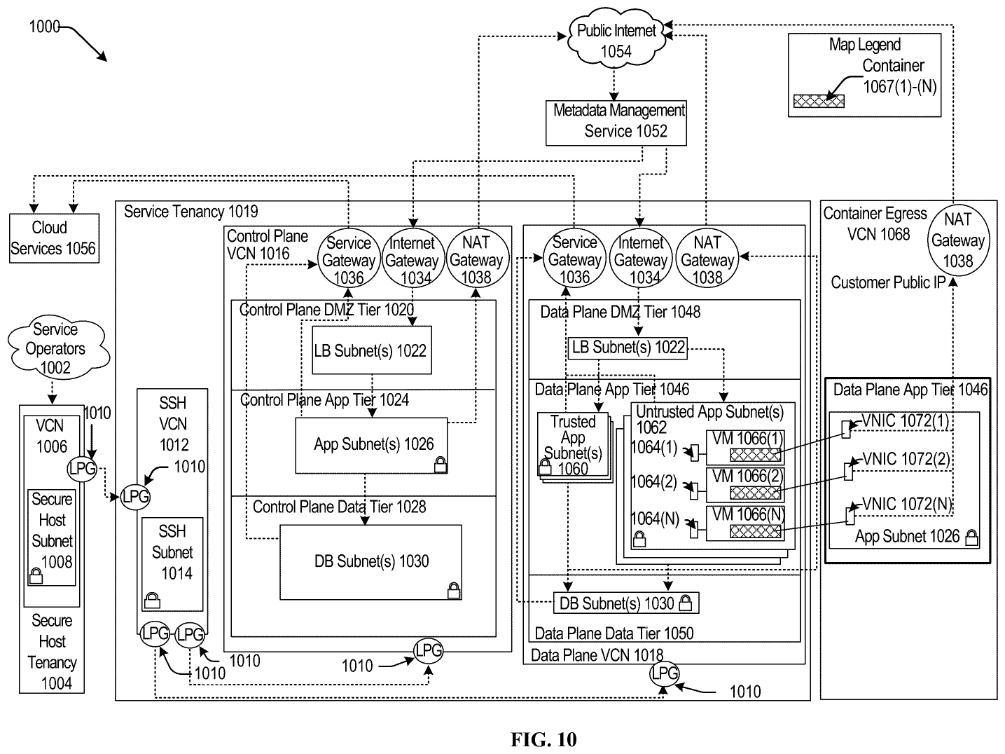

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a VCN 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 717 of FIG. 7) via an LPG 1010 contained in the control plane VCN 1016 and to a data plane VCN 1018 (e.g., the data plane VCN 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 830 of FIG. 8). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 860 of FIG. 8) and untrusted app subnet(s) 1062 (e.g., untrusted app subnet(s) 862 of FIG. 8) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management service 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processing unit(s) 1104 and/or in storage subsystem 1118. Through suitable programming, processing unit(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may include a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments, communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A non-transitory computer-readable medium comprising instructions that are configured, when executed by a processor, to perform operations comprising:
receiving, from a service executing in a service tenancy and by an event broker, a request to modify a rule to deliver a set of events from a first tenancy to the service tenancy, wherein modify comprises at least one of create or update;
receiving, from the service and by the event broker, a proxy token for substantiating the request, wherein the proxy token represents an authority of a user principal of the first tenancy;
determining, by the event broker, whether modification of the rule is authorized based at least on the authority of the user principal; and
subsequent to determining that the modification of the rule is authorized, delivering, by the event broker, the set of events from the first tenancy to the service tenancy according to the rule.

2. The non-transitory computer-readable medium of claim 1, wherein the authority of the user principal is based at least on an access policy that permits the user principal to inspect the set of events in the first tenancy.

3. The non-transitory computer-readable medium of claim 1, wherein the authority of the user principal is based at least on an access policy that permits the user principal to manage rules in the first tenancy.

4. The non-transitory computer-readable medium of claim 1, wherein the authority of the user principal is based at least on a cross-tenancy access policy pair that permits the user principal to modify the rule, wherein the cross-tenancy access policy pair comprises an endorse rule in the service tenancy and an admit rule in an events tenancy, wherein the event broker executes in the events tenancy.

5. The non-transitory computer-readable medium of claim 1, wherein the service is a machine learning (ML) pipeline service.

6. The non-transitory computer-readable medium of claim 4, wherein the proxy token is associated with one or more characteristics comprising:
has an expiry time; or
is revocable by the user principal prior to the expiry time.

7. The non-transitory computer-readable medium of claim 4, wherein:
the request to modify the rule comprises a condition string;
the rule comprises the condition string; and
the condition string is used to match the set of events to a particular type of event.

8. The non-transitory computer-readable medium of claim 4, wherein:
the request to modify the rule comprises a pipeline stream identifier;
the pipeline stream identifier identifies a pipeline stream; and
the event broker delivers, in accordance with the rule, the set of events to the pipeline stream within the service tenancy in accordance with the pipeline stream identifier.

9. The non-transitory computer-readable medium of claim 8, wherein the set of events are delivered to the pipeline stream in real time.

10. The non-transitory computer-readable medium of claim 8, wherein the pipeline stream is owned and managed by the service.

11. The non-transitory computer-readable medium of claim 1, the operations further comprising:
receiving, from the service and by the event broker, a request to update the rule, wherein the request to update the rule comprises an identifier for the rule.

12. The non-transitory computer-readable medium of claim 11, wherein:
the set of events represents a set of dataflow run events;
each dataflow run event of the set of dataflow run events comprises a tag; and
the tag is used to filter its respective dataflow run event such that the event broker only delivers a subset of dataflow run events from the set of dataflow run events that are created by the service to the service tenancy.

13. The non-transitory computer-readable medium of claim 12, wherein the tag is generated as part of creation of its respective dataflow run event.

14. The non-transitory computer-readable medium of claim 1, the operations further comprising deleting, by the event broker, the rule in response to determining that the rule is not associated with any pipeline runs in progress.

15. The non-transitory computer-readable medium of claim 1, wherein the first tenancy is a secure and isolated partition within an infrastructure of the event broker.

16. The non-transitory computer-readable medium of claim 1, wherein the rule is associated with a rule identifier and a pipeline run compartment identifier.

17. The non-transitory computer-readable medium of claim 16, wherein the rule identifier and the pipeline run compartment identifier are stored in a rule bucket.

18. The non-transitory computer-readable medium of claim 17, wherein the rule bucket is not accessible by the first tenancy.

19. A system, comprising:
one or more processors; and
a non-transitory computer-readable medium comprising instructions that are configured, when executed by the one or more processors, to perform operations comprising:
receiving, from a service executing in a service tenancy and by an event broker, a request to modify a rule to deliver a set of events from a first tenancy to the service tenancy, wherein modify comprises at least one of create or update;
receiving, from the service and by the event broker, a proxy token for substantiating the request, wherein the proxy token represents an authority of a user principal of the first tenancy;
determining, by the event broker, whether modification of the rule is authorized based at least on the authority of the user principal; and
subsequent to determining that the modification of the rule is authorized, delivering, by the event broker, the set of events from the first tenancy to the service tenancy according to the rule.

20. A method by one or more computing systems, comprising:
receiving, from a service executing in a service tenancy and by an event broker, a request to modify a rule to deliver a set of events from a first tenancy to the service tenancy, wherein modify comprises at least one of create or update;
receiving, from the service and by the event broker, a proxy token for substantiating the request, wherein the proxy token represents an authority of a user principal of the first tenancy;
determining, by the event broker, whether modification of the rule is authorized based at least on the authority of the user principal; and
subsequent to determining that the modification of the rule is authorized, delivering, by the event broker, the set of events from the first tenancy to the service tenancy according to the rule.
